(19) United States
(12) Patent Application Publication
(10) Pub. No.: US 2026/0291187 A1
(43) Pub. Date: Sep. 24, 2026

(54) INSULATING SHIELD FOR HARDWARE ON SWITCHGEAR

(71) Applicant: G & W Electric Company, Bolingbrook, IL (US)

(72) Inventors: Sterlin Cochran, Naperville, IL (US); Arturas Dauksas, Oak Lawn, IL (US)

(21) Appl. No.: 19/577,030

(22) Filed: Mar. 24, 2026

Related U.S. Application Data
(60) Provisional application No. 63/776,760, filed on Mar. 24, 2025.

(51) Int. Cl. H02B 13/045

(52) U.S. Cl. CPC H02B 13/045

(57) ABSTRACT

An insulating shield configured to insulate hardware coupling an electrical equipment component to a substrate includes a nut configured to engage the hardware and to be tightened to couple the electrical equipment component to the substrate, a shroud configured to surround and electrically insulate the nut, and a sealing ring surrounding the hardware and configured to engage the substrate to form an insulating seal against the substrate in response to tightening the nut.

### CROSS-REFERENCE TO RELATED APPLICATIONS

The present application claims priority to co-pending U.S. Provisional Patent Application No. 63/776,760, filed Mar. 24, 2025, the entire content of which is incorporated herein by reference.

### FIELD OF THE DISCLOSURE

The present disclosure relates to switchgear, and, more particularly, to a protective insulating shield for hardware on gas insulated switchgear.

### BACKGROUND OF THE DISCLOSURE

Electrical switchgear is often positioned within a sealed tank containing sulfur hexafluoride (SF6) gas. The high dielectric performance of SF6 allows for compact switchgear designs and reduces the potential for arcing between exposed conductive components, such as hardware. Although SF6 has very high dielectric performance, however, it is a greenhouse gas that is increasingly the subject of regulations restricting its use.

### SUMMARY

Accordingly, a need exists for improved insulation for electrical switchgear, as well as transformers and other components used in medium or high voltage power transmission and distribution systems, without relying upon SF6 gas. Mechanical hardware for assembling such electrical equipment and mounting various components can be a source of arcing due to the typically sharp geometries and metallic nature of the hardware components. The present disclosure provides, among other things, insulating shields for electrical equipment hardware to improve dielectric performance. Such insulated hardware may be advantageous in a wide variety of applications, and particularly for equipment in medium and high voltage systems that do not use SF6 gas.

In some aspects, the techniques described herein relate to an insulating shield configured to insulate hardware coupling an electrical equipment component to a substrate, the insulating shield including: a nut configured to engage the hardware and to be tightened to couple the electrical equipment component to the substrate; a shroud configured to surround and electrically insulate the nut; a sealing ring surrounding the hardware and configured to engage the substrate to form an insulating seal against the substrate in response to tightening the nut.

In some aspects, the techniques described herein relate to a switchgear assembly including: an enclosure containing a non-SF6 insulating gas; a switchgear component mounted to a substrate of the enclosure via a bolt and a nut; a shroud surrounding and electrically insulating a distal end of the bolt and the nut; a sealing ring surrounding the bolt and engaging the substrate to form an insulating seal against the substrate in response to tightening the nut.

Other features and aspects of the present disclosure will become apparent upon consideration of the following description and accompanying drawings.

### BRIEF DESCRIPTION OF THE DRAWINGS

FIG. 1 illustrates a perspective view of a switchgear assembly.

FIG. 2 illustrates a cross-sectional view of the switchgear assembly of FIG. 1.

FIG. 3 illustrates a perspective view of hardware with first and second protective insulating shields embodying aspects of the present disclosure.

FIG. 4 illustrates a cross-sectional view of hardware with the first protective insulating shield of FIG. 3.

FIG. 5 illustrates a cross-sectional view of hardware with the second protective insulating shield of FIG. 3.

FIG. 6 illustrates sealing hardware that may be used with the protective insulating shield of FIG. 4.

FIG. 7 illustrates sealing hardware that may be used with the protective insulating shield of FIG. 5.

FIG. 8 is a perspective view of hardware with a protective insulating shield according to another embodiment of the present disclosure.

FIG. 9 is an exploded view of the protective insulating shield of FIG. 8.

FIG. 10 is a cross-sectional view of the protective insulating shield of FIG. 8.

FIG. 11 is a partially-exploded cross-sectional view of the protective insulating shield of FIG. 8.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein and in the appended claims, the terms “upper”, “lower”, “top”, “bottom”, “front”, “back”, and other directional terms are not intended to require any particular orientation but are instead used for purposes of description only.

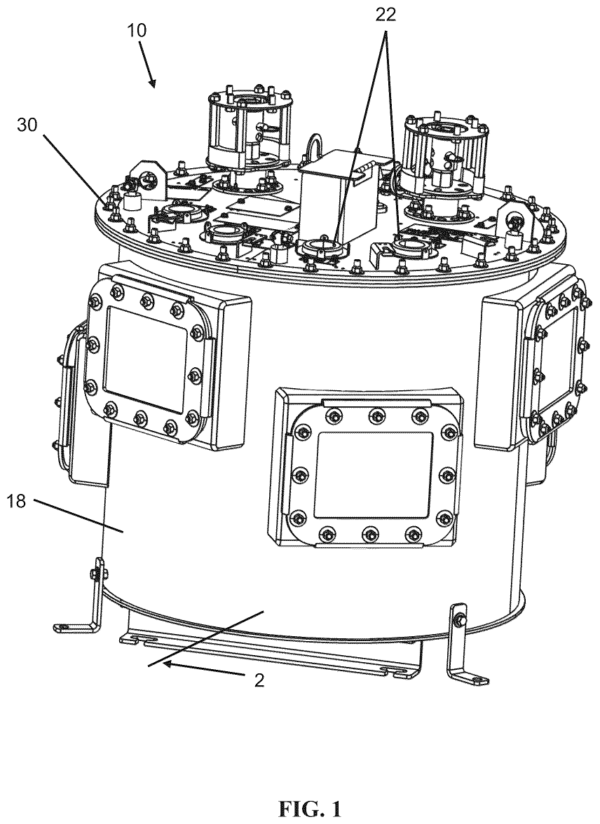

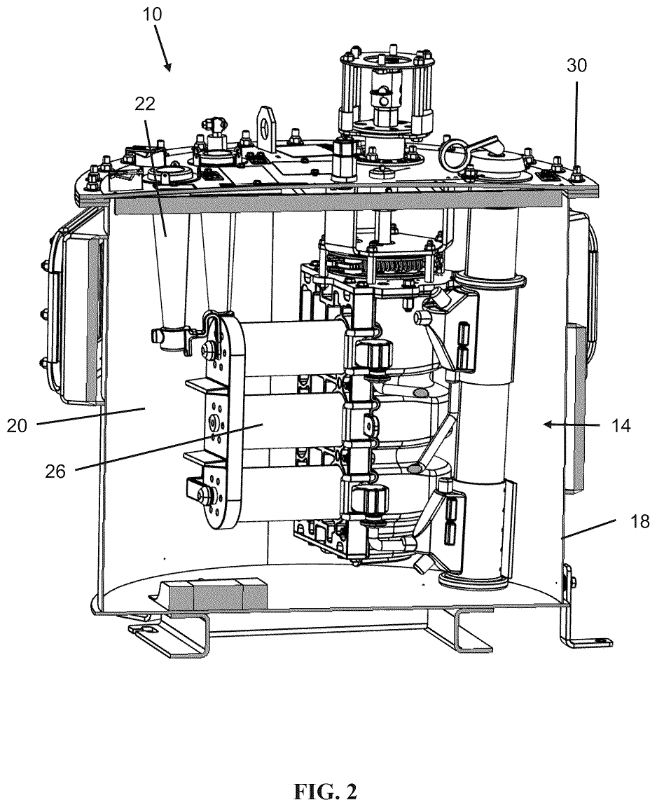

FIGS. 1 and 2 illustrate an exemplary embodiment of electrical equipment in which protective insulating shields embodying aspects of the present disclosure may be incorporated. The illustrated electrical equipment is a switchgear assembly 10 including switchgear 14 (FIG. 2) supported within an enclosure 18, which may be made of metal in some embodiments. The switchgear 14 includes one or more electrical connections 22 (e.g., bushings) configured for connection to a power source or load via suitable connectors (e.g., cables, busbars, and the like), and other electrical components 26, such as vacuum interrupters, arrestors, transformers, and the like, that may all be energized at a high voltage (e.g., 5 kV, 15 kV, 25 kV, 35 kV, etc.). The electrical components 26 are all housed within an internal space 20 defined by the enclosure 18. In some embodiments, the enclosure 18 may be filled with an inert gas, which may be a non-SF6 gas, and particularly a natural origin gas such as CO2, Nitrogen, or air. The gas in the enclosure 18 may be pressurized above atmospheric pressure in some embodiments.

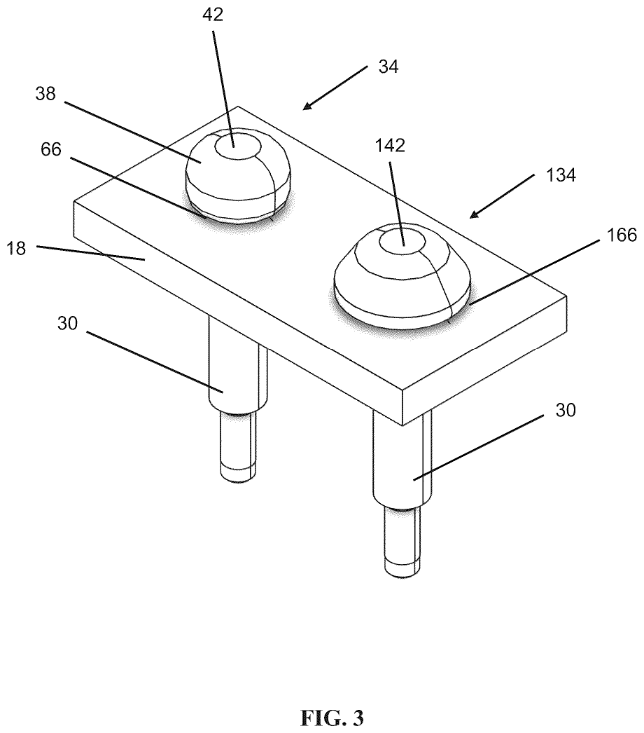

To secure the electrical components 26 of the switchgear 14 within the enclosure 18, hardware 30, such as threaded bolts, may be used. FIGS. 3-5 illustrate protective insulating shields 34, 134 for use with hardware 30 of the switchgear assembly 10 (or with hardware 30 of other electrical equipment) to prevent arcing. In particular, FIG. 3 illustrates first and second protective insulating shields 34, 134, which may be incorporated individually (i.e., as alternatives) or in combination in various applications.

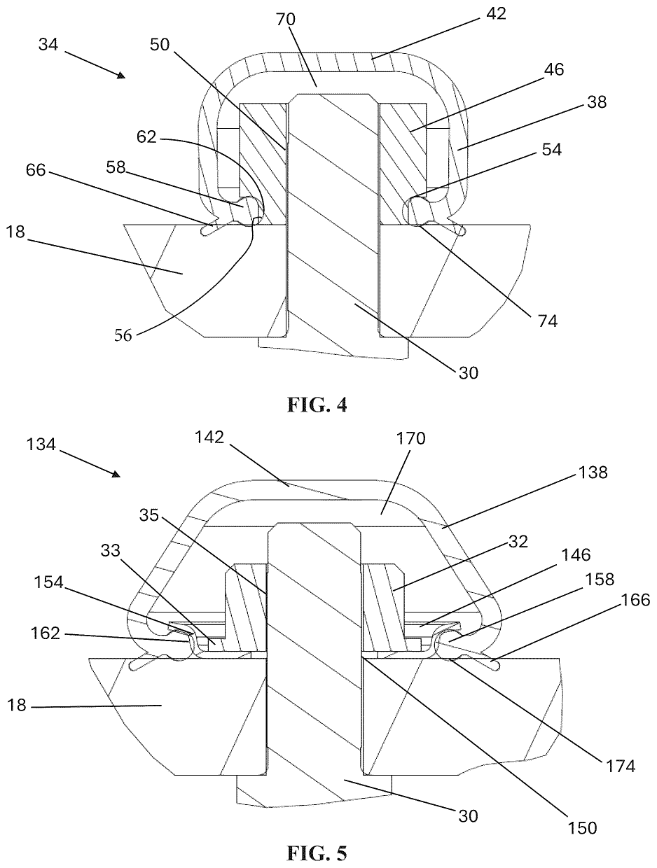

With reference to FIGS. 3 and 4, the illustrated first protective insulating shield 34 includes an elastomeric shroud 38 forming a dome 42 over the hardware 30. The elastomeric shroud 38 can be made of a silicon rubber, EDPM rubber, or other elastic materials having similarly high dielectric properties, and, in some embodiments, may be formed as a single unitary body (e.g., via a suitable molding process).

With reference to FIG. 4, the protective insulating shield 34 further includes sealing hardware 46, which is a nut in the illustrated embodiment. The dome 42 is configured to cover a distal end of the bolt 30 and the nut 46 such that an air gap 70 is defined therebetween. The air gap 70 and the rounded shape of the dome 42 reduces electrical stress concentrations and inhibit arcing. Although the air gap 70 is referred to herein as an “air gap,” the air gap 70 may also contain other types of gases, such as the non-SF6 insulating gas contained within the enclosure 18.

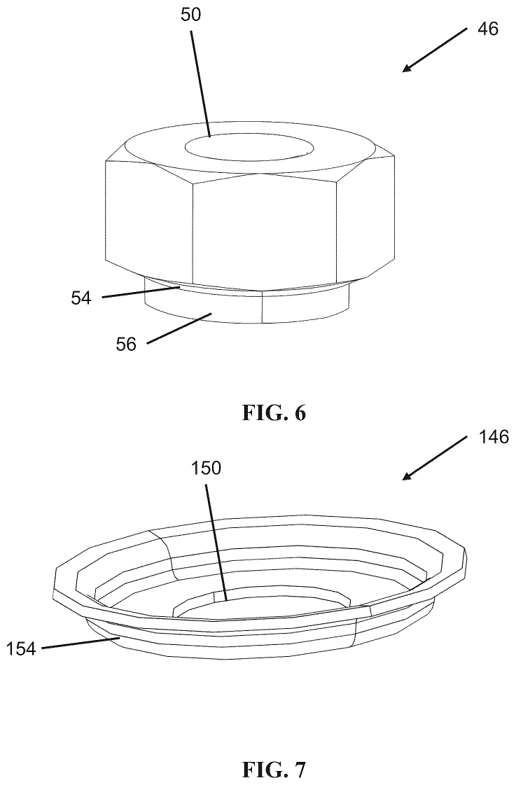

Best illustrated in FIG. 6, the illustrated nut 46 has a bore 50 with a plurality of threads (not shown) for threading onto the bolt 30, a shoulder 54 for engagement with the shroud 38, and a rounded groove 56 extending from the shoulder 54 and defining a reduced-diameter portion of the nut 46. The shroud 38 further includes an annular O-ring portion 58 defining an opening 62 of the shroud 38 opposite the dome 42, and a skirt portion 66 integrally formed with and extending outwardly from the O-ring portion 58 (FIG. 4). Together, the shroud 38 and the nut 46 form a protective insulating seal between the shaft of the bolt 30 and the interior of the enclosure 18 to prevent arcing of the bolt 30 with other electrical components 26 of the switchgear 14 or the external environment during operation of the switchgear 14, as described in greater detail below.

With continued reference to FIG. 4, in use, a component of the electrical equipment (e.g., switchgear 14) is fastened to a structure (e.g., the enclosure 18 or any other desired structure in other embodiments) by inserting the bolt 30 through an opening in the enclosure 18 and then threading the nut 46 on to the bolt 30 until the enclosure or substrate 18 is clamped therebetween (e.g., to a desired or specified torque). Next, the O-ring portion 58 of the dome 42 is stretched to a diameter wider than the diameter of the nut 46, such that the nut 46 can be inserted into the dome 42 through the opening 62 in the O-ring portion 58. Once the O-ring portion 58 clears the shoulder 54, the resilient material elastically recovers to pull the O-ring portion 58 into the groove 56. The O-ring portion 58 presses against the groove 56 in a radially-inward direction, thereby forming an improved seal between the O-ring portion 58 and the nut 46.

With continued reference to FIG. 4, the groove 56 may have a height slightly less than a thickness of the O-ring portion 58, such that the O-ring portion 58 is also axially compressed by the groove 56. This axial compression provides an improved seal between the bottom of the O-ring portion 58 and a mating surface 74 of the enclosure 18 (or other substrate) surrounding the hardware 30. The skirt portion 66, which in the illustrated embodiment extends below the bottom of the O-ring portion 58, is also pressed against the mating surface 74 due to the axial compression, providing a second seal against the mating surface 74 surrounding the seal created by the O-ring portion 58.

FIGS. 3 and 5 illustrate the second protective insulating shield 134 for use with mating hardware 30 on the switchgear assembly 10 or other electrical equipment. Components and features corresponding with components and features of the first protective insulating shield 34 will designated the same reference numbers plus “100.”

The protective shield 134 includes an elastomeric shroud 138 forming a dome 142 over the mating hardware 30, 32 (e.g., a bolt and a flange nut having a flange 33) on the enclosure 18. The elastomeric shroud 138 can be made of a silicon rubber, EDPM rubber, or other elastic materials having similarly high dielectric properties. With reference to FIG. 5, the protective insulating shield 134 further includes sealing hardware 146, such as a washer (FIG. 7), having a bore 150 for receiving the hardware 30, and a shoulder 154 for engagement with the shroud 138 and the metal enclosure 18.

The shroud 138 further includes an annular O-ring portion 158 radially disposed about an opening 162 of the shroud 138 opposite the dome 142, and a skirt portion 166 integrally formed with the O-ring portion 158 to form a flange connection between the shroud 138 and the enclosure 18. Together, the shroud 138 and the washer 146 form a protective insulating seal between the hardware 30, 32 and the enclosure 18 to prevent arcing of the hardware 30, 32 with other electrical components 26 of the switchgear 14 or the external environment during operation of the switchgear 14. Additionally, the protective insulating shield 134 is configured to prevent arcing by uniformly redirecting any electrical stresses transferred to or from the hardware 30, 32 to the dome 42 across an air gap 170 formed between the hardware 30, 32 and the shroud 138. Although the air gap 170 is referred to herein as an “air gap,” the air gap 170 may also contain other types of gases, such as the non-SF6 insulating gas contained within the enclosure 18.

With continued reference to FIG. 5, in use, the O-ring portion 158 and the skirt portion 166 form seals against the washer 146 and the mating surface 174 of the enclosure 18 (or other substrate) in a similar manner as the O-ring portion 58 and skirt portion 66 described above with reference to FIG. 4. However, rather than the groove 56 being defined by the nut 46 itself, a groove for receiving the O-ring portion 58 is instead defined by the washer 146. Thus, the insulating shield 134 may advantageously be used with existing standard hardware (e.g., standard bolts and nuts).

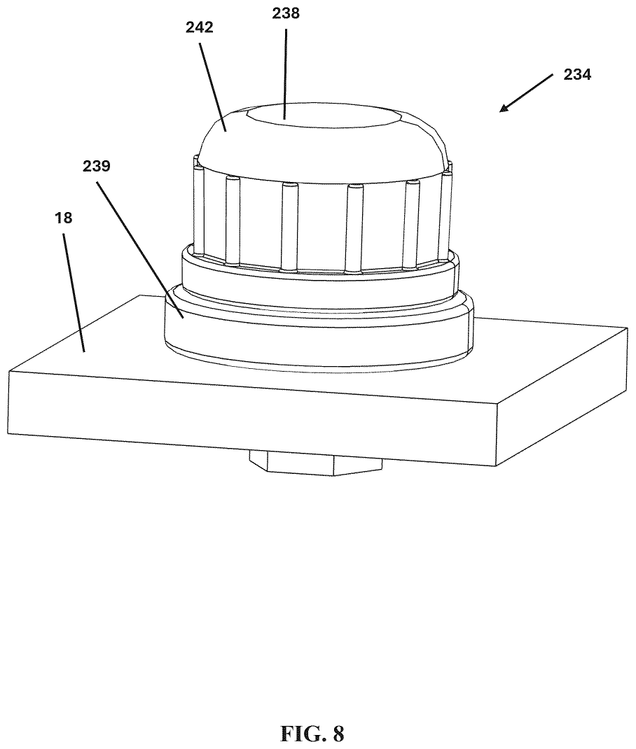

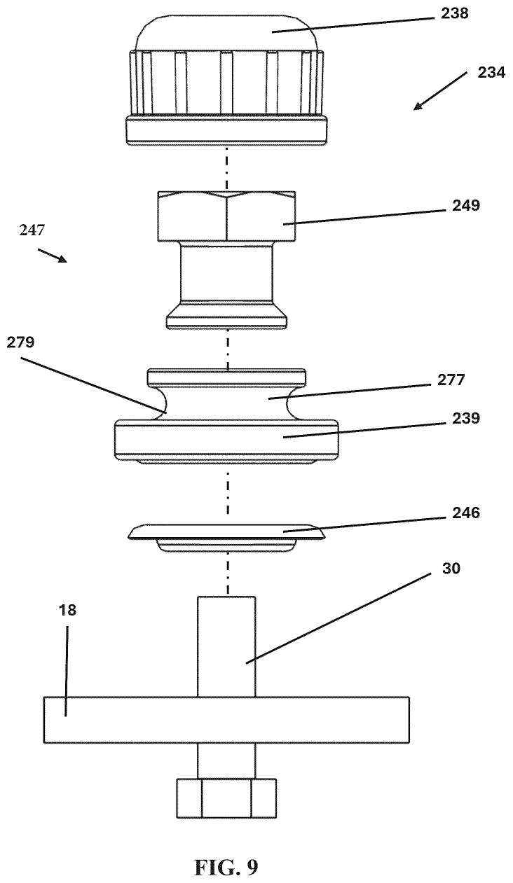

FIGS. 8-11 illustrate a third protective insulating shield 234 for use with mating hardware 30 on the switchgear assembly 10 or other electrical equipment. The insulating shield 234 is similar in some aspects to the second protective insulating shield 134 described above. Components and features corresponding with components and features of the second protective insulating shield 134 will designated the same reference numbers plus “100.”

The protective shield 234 includes an elastomeric shroud 238, an elastomeric collar 239, and sealing hardware 247 including a washer 246 and a nut 249. The shroud 238 forms a dome 242 over the nut 249 and the distal end of the bolt 30. The collar 239 forms a seal between the washer 246 and the substrate or enclosure 18. The shroud 238 and the collar 239 can be made of a silicon rubber, EDPM rubber, or other elastic materials having similarly high dielectric properties. In some embodiments, the shroud 238 and the collar 239 may be made of the same or different materials.

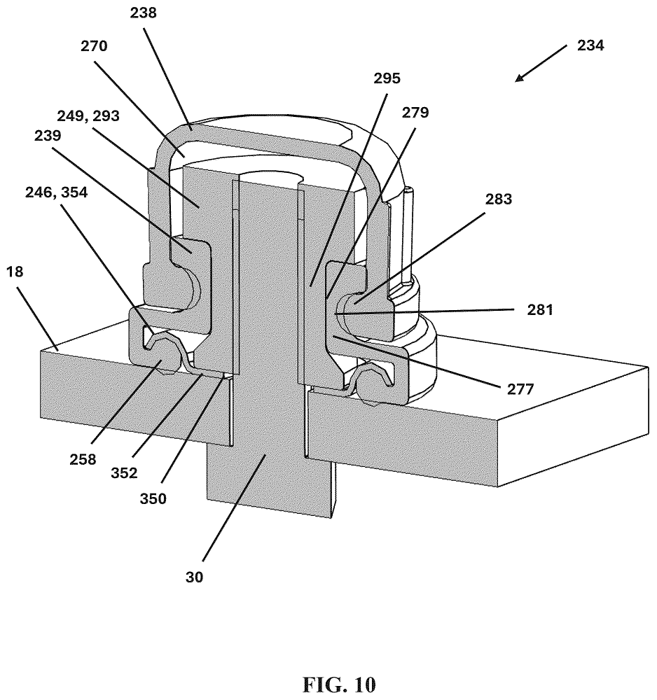

With reference to FIG. 10, the washer 246 has a bore 350 for receiving the hardware 30, a flat region 352 surrounding the bore 350, and a curved shoulder 354 surrounding the flat region 352. The collar 239 includes an annular O-ring portion 258 extending radially inwardly from a bottom end of the collar 239 opposite the shroud 238. The O-ring portion 258 is configured to be received between the curved shoulder 354 of the washer 246 and the substrate or enclosure 18 and compressed to form an insulating seal, as described in greater detail below.

The collar 239 includes a neck portion 277 having a smaller outer diameter than a base portion of the collar 239 that defines the O-ring portion 258. The neck portion 277 defines a bore 279 through which the bolt 30 and the nut 249 extend. A curved groove 281 is defined on an exterior side of the neck portion 277 (opposite the bore 279). The shroud 238 includes an O-ring portion 283 extending radially inwardly at a bottom end of the shroud 238. The O-ring portion 283 is configured to be received within the groove 281 of collar 239 to form an insulating seal.

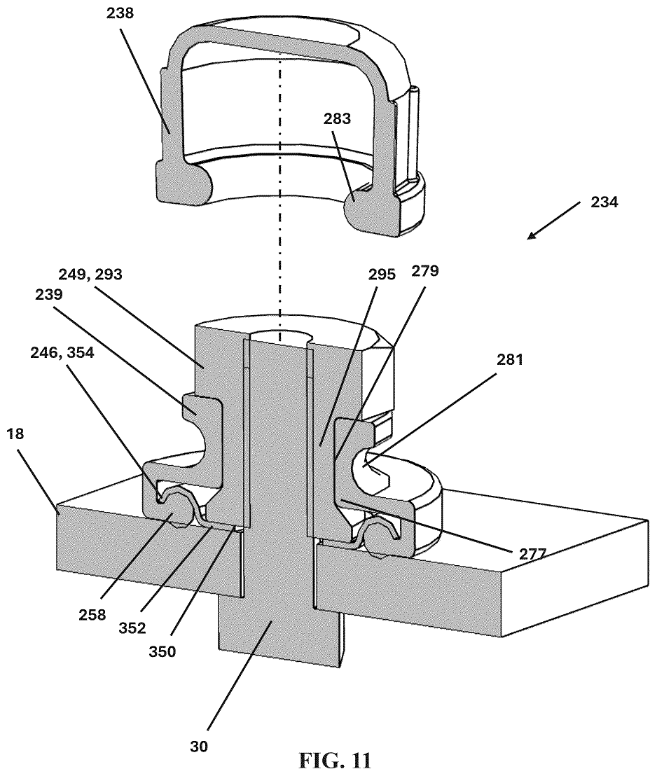

With reference to FIG. 11, in use, the nut 249 is inserted through the bore 279 in the collar 239 until a head 293 of the nut 249, which in the illustrated embodiment has a hexagonal shape, abuts an upper end of the collar 239 and an extension portion 295 of the nut 249, which has a smaller diameter than the head 293 of the nut 249, extends through the neck portion 277 of the collar 239. Then, the washer 246 is inserted into the base portion of the collar 239 and oriented so that the curved shoulder 354 is positioned above the O-ring portion 258 of the collar 239. In this position, the flat region 352 of the washer 246 may engage a bottom end of the nut 249.

Next, the nut 249 may be aligned with the bolt 30 and tightened on to the bolt 30 to a desired torque specification. Because the head 293 of the nut 249 is exposed at this point, it can be easily accessed with a wrench, socket, or other suitable tool. As the nut 249 is tightened on to the bolt 30, the nut 249 presses the washer 246 into the substrate 18, and the washer 246 in turn compresses the O-ring portion 258 of the collar 239 to form a protective insulating seal around the bolt 30 against the surface of the substrate 18.

Once the nut 249 is tightened, the shroud 238 is stretched over the head 293 of the nut 249, and the nut 249 is inserted into the shroud 238 until the O-ring portion 283 of the shroud 238 reaches the groove 281 on the outside of the collar 239. The shroud 238 can then be released, and it elastically recovers to compress the O-ring portion 283 into the groove 281. This forms a protective insulating seal at the interface between the shroud 238 and the collar 239. Because both the shroud 238 and the collar 239 are made of elastomeric insulating materials in the illustrated embodiment, the hardware—including the bolt 30 and nut 249—are thus enclosed and insulated to prevent arcing of the hardware 30 with other electrical components 26 of the switchgear 14 or the external environment during operation of the switchgear 14. Additionally, the protective insulating shield 234 is configured to prevent arcing by uniformly redirecting any electrical stresses transferred to or from the hardware 30 to the dome 242 across an air gap 270 formed between the hardware 30 and the shroud 238. Although the air gap 270 is referred to herein as an “air gap,” the air gap 270 may also contain other types of gases, such as the non-SF6 insulating gas contained within the enclosure 18. Advantageously, in each embodiment of the protective insulating shield 34, 134, 234, when the hardware is tightened to its normal torque specifications, no clamping force is translated to the elastomeric shrouds 38, 138, 238, thereby maintaining the air gap 70, 170, 270.

Thus, the present disclosure provides, in some aspects, a protective insulating hardware shield (34, 134, 234) that may be positioned on a live or elevated potential side of a substrate—such as the inner side of a switchgear enclosure. By providing an insulating barrier between the hardware, which may be grounded or at a different potential, and live components within the enclosure, the insulating shield may inhibit or prevent undesirable electrical arcing to the hardware, with the seal between the insulating shield and the enclosure preventing or inhibiting creepage or tracking, which is particularly important in an environment with insulating gas (e.g., air, CO2, etc.) having lower dielectric performance than SF6.

Although the disclosure has been described in detail with reference to certain preferred embodiments, variations and modifications exist within the scope and spirit of one or more independent aspects of the disclosure as described.

Various features and advantages of the disclosure are set forth in the following claims.

What is claimed is:

1. An insulating shield configured to insulate hardware coupling an electrical equipment component to a substrate, the insulating shield comprising:
a nut configured to engage the hardware and to be tightened to couple the electrical equipment component to the substrate;
a shroud configured to surround and electrically insulate the nut;
a sealing ring surrounding the hardware and configured to engage the substrate to form an insulating seal against the substrate in response to tightening the nut.

2. The insulating shield of claim 1, wherein the shroud is made of an elastomeric material.

3. The insulating shield of claim 1, further comprising an air gap between the shroud and the nut.

4. The insulating shield of claim 1, further comprising a washer positioned between the nut and the substrate.

5. The insulating shield of claim 4, wherein the washer includes a wall configured to engage and compress the sealing ring in response to the nut bearing against the washer.

6. The insulating shield of claim 5, further comprising a collar surrounding the nut, wherein the collar includes an O-ring portion defining the sealing ring.

7. The insulating shield of claim 6, wherein the collar is made of an elastomeric material.

8. The insulating shield of claim 6, wherein the collar includes a bore configured to receive the hardware and the nut such that the hardware and the nut pass through the bore, and wherein the collar includes a groove on an outside of the collar opposite the bore.

9. The insulating shield of claim 8, wherein the sealing ring is a first sealing ring, and wherein the insulating shield further comprises a second sealing ring received in the groove to form an insulating seal between the collar and the shroud.

10. The insulating shield of claim 9, wherein the shroud includes an O-ring portion defining the second sealing ring.

11. The insulating shield of claim 1, wherein the shroud includes an O-ring portion defining the sealing ring.

12. A switchgear assembly comprising:
an enclosure containing a non-SF6 insulating gas;
a switchgear component mounted to a substrate of the enclosure via a bolt and a nut;
a shroud surrounding and electrically insulating a distal end of the bolt and the nut;
a sealing ring surrounding the bolt and engaging the substrate to form an insulating seal against the substrate in response to tightening the nut.

13. The switchgear assembly of claim 12, wherein the shroud is made of an elastomeric material.

14. The switchgear assembly of claim 12, further comprising an air gap between the shroud and the nut.

15. The switchgear assembly of claim 12, further comprising a washer positioned between the nut and the substrate.

16. The switchgear assembly of claim 15, wherein the washer includes a wall configured to engage and compress the sealing ring in response to the nut bearing against the washer.

17. The switchgear assembly of claim 12, further comprising a collar surrounding the nut, wherein the collar includes an O-ring portion defining the sealing ring, and wherein the collar is made of an elastomeric material.

18. The switchgear assembly of claim 17, wherein the collar includes a bore configured to receive the bolt and the nut such that the bolt and the nut pass through the bore, and wherein the collar includes a groove on an outside of the collar opposite the bore.

19. The switchgear assembly of claim 18, wherein the sealing ring is a first sealing ring, wherein the switchgear assembly further comprises a second sealing ring received in the groove to form an insulating seal between the collar and the shroud, and wherein the shroud includes an O-ring portion defining the second sealing ring.

20. The switchgear assembly of claim 12, wherein the shroud includes an O-ring portion defining the sealing ring.
